(19) United States
(12) Patent Application Publication
(10) Pub. No.: US 2018/0001501 A1
(43) Pub. Date: Jan. 4, 2018

(54) MULTIPLE-AXIS ARTICULATING MEMBER AND METHOD FOR MAKING SAME

(71) Applicant: Unique Fabricating, Inc., Auburn Hills, MI (US)

(72) Inventor: David J. Andre, Clinton Township, MI (US)

(73) Assignee: Unique Fabricating, Inc., Auburn Hills, MI (US)

(21) Appl. No.: 15/611,270

(22) Filed: Jun. 1, 2017

Related U.S. Application Data
(60) Provisional application No. 62/345,236, filed on Jun. 3, 2016.

(51) Int. Cl. B26F 1/02

(52) U.S. Cl. CPC B26F 1/02

(57) ABSTRACT

An articulating member adapted to articulate about multiple axes and method for making same is disclosed. The articulating member may comprise an articulating section that allows for the articulating member to articulate laterally, vertically, or both so that the articulating member may be articulated to fit along the contour of a substrate and be adhered or affixed thereto. The articulating section may be arranged in a corrugated pattern with alternating ridges and furrows. The geometry of the articulating section is such that the stress concentrations along the various surfaces of the articulating member may be reduced when the member is articulated laterally, vertically, or both. The method comprises the steps of providing a die being shaped with geometry that will produce an articulating member, and machining a sheet of material to produce an articulating member.

### CROSS-REFERENCE TO RELATED APPLICATIONS

This application claims priority to U.S. Provisional Application No. 62/345,236, filed Jun. 3, 2016, which is incorporated herein by reference in its entirety.

### BACKGROUND OF THE DISCLOSURE

In many industries, non-rigid members may be configured to articulate so that they may be adapted to fit along the contour of a particular substrate. This may allow for the member to sit substantially flush with the substrate such that the member may be effectively adhered or affixed thereto. For instance, foam strips can be configured to fit along the contour of a duct seal by wrapping around the seal. Foam strips can also be configured to fit along the contour of a particular part to secure and protect the part during shipment (i.e., packaging dunnage). Moreover, members can be used to fit along the intricate contours of interior panels of an automobile. Substrates to which members can be adhered or affixed may sometimes have complex contours, such as curved and other non-planar contours. Accordingly, manufacturers are pressed with considering how to adapt members to fit the contour of particular substrates such that they may be effectively adhered or affixed thereto.

Manufacturers have positioned slits, notches, perforations, and the like into various surfaces of members to reduce the stress concentrations that form along these surfaces when a member is articulated. While these types of cuts may reduce stress concentrations, they may limit the member to articulation about a single axis, which limits how the part may be oriented to fit along the contour of a substrate. Moreover, they may create failure paths (or fracture paths) that may lead to material waste and inferior structural integrity of the member. In some cases, a one-piece member having one of the noted cuts is not capable of fitting the complex contour of a substrate due to its noted limitations. Consequently, multiple parts are glued or fixed together in order to completely fit the material along the substrate contour.

In addition, many times members have a surface coated with an adhesive and a protective laminate layer. The adhesive coating and laminate layer are typically applied to one surface of a larger sheet of material for efficiency purposes before being machined or formed into the desired member shape. For a member to be properly adhered to a substrate with a complex contour, an additional process is sometimes undertaken to apply an adhesive coating and laminate layer to additional surfaces of the member. This additional process may be time consuming and labor intensive.

Moreover, when members are formed into complex shapes using manufacturing processes, such as die cutting, laser cutting, or water jet cutting, an undesirable amount of scrap may be created because the complex member shapes cannot be efficiently nested or closely laid out on the large material sheet. For example, if a die is pressed into material to form a member resembling the letter “J”, an undesirable amount of material may be scrapped due to the asymmetry of the letter “J”. Furthermore, an additional process of coating and laminating the bottom or side of the “J” might still be necessary to properly adhere or affix the member to a substrate.

Thus, members are needed that may articulate in multiple axes to fit and be adhered to a complex substrate contour. Methods for making such a member are also needed.

### SUMMARY

In one embodiment, an articulating member comprises at least one articulating section that allows for articulation of the member about multiple axes such that it may fit the contour of a substrate and be adhered or affixed thereto.

In another embodiment, a method for making an articulating member is disclosed. The method generally comprises the steps of providing the member pattern and cutting/machining/layering the material such that an articulating member is formed.

### BRIEF DESCRIPTION OF THE DRAWINGS

FIG. 1 is a perspective view of an exemplary articulating member;

FIG. 2 is a top plan view of an exemplary articulating member;

FIG. 3 is a top plan view of an exemplary articulating member having an articulation section with twelve ridges and twelve furrows;

FIG. 4 is a top plan view of an exemplary articulating member having an articulation section with one ridge and one furrow;

FIG. 5 is a top plan view of an exemplary articulating member having two articulating sections;

FIG. 6 is a top plan view of an exemplary articulating member having a first member section and an articulating section;

FIG. 7 is a top plan view of an exemplary articulating member;

FIG. 8 is a bottom, side perspective view of an exemplary articulating section of an articulating member;

FIG. 9 is a top plan view of one exemplary articulating member showing a reference longitudinal plane along its length;

FIG. 10 is a close up view of Section A from FIG. 9;

FIG. 11 is a cross section view taken from line B-B of FIG. 10;

FIG. 12 is a cross section view of an exemplary articulating section;

FIG. 13 is a perspective view of an exemplary articulating member being articulated laterally;

FIG. 14 is a perspective view of an exemplary articulating member being articulated vertically;

FIG. 15 is a perspective view of an exemplary articulating member being articulated both laterally and vertically;

FIG. 16 is a perspective view of an exemplary articulating member having been applied to a substrate;

FIG. 17 is a front, perspective view of an exemplary articulating member;

FIG. 18 is a view of a steel rule die for making articulating members; and

FIG. 19 is a top plan view of a sheet of material being transformed into multiple articulating members; and

FIG. 20 is a top plan view of an exemplary articulating member.

### DETAILED DESCRIPTION

Multiple embodiments of an articulating member 2 are described with reference to the drawings, wherein like numerals reference like structures. Although articulating member 2 may be illustrated and described herein as including particular components in a particular configuration, the components and configuration shown and described are provided for example purposes only. The figures and descriptions of the embodiments described herein are not intended to limit the breadth or the scope of the inventive concepts or the appended claims in any manner. Rather, the figures and detailed descriptions of articulating member 2 are provided to illustrate the inventive concepts to a person of ordinary skill in the art and to enable such person to make and use the inventive concepts.

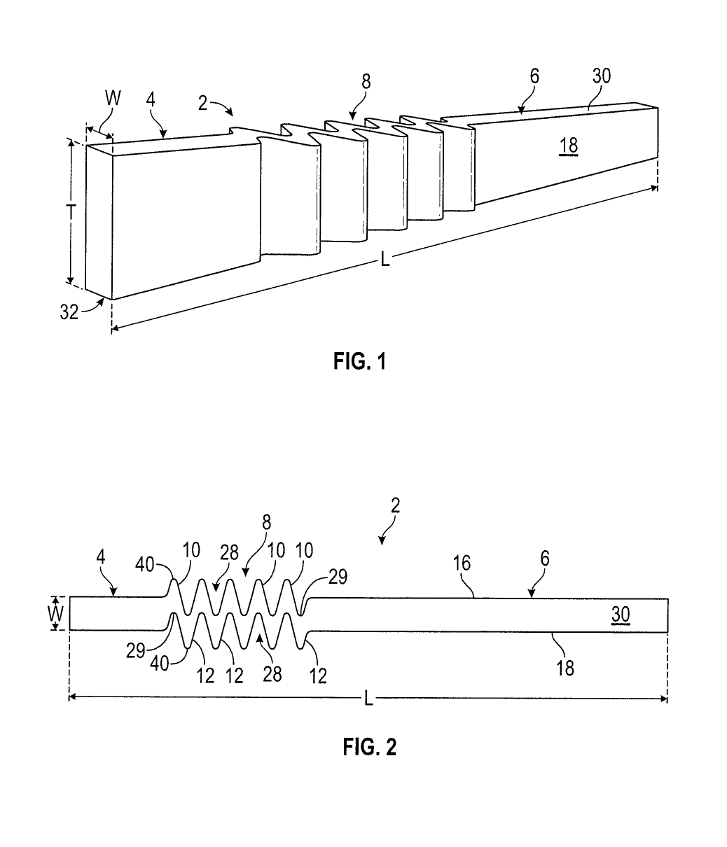

Turning now to the drawings, FIG. 1 depicts an exemplary articulating member 2 that may be adapted to fit the contour of a substrate and be adhered or affixed thereto. The articulating member 2 may have a first member section 4, a second member section 6, and an articulating section 8 located therebetween. Articulating section 8 allows for articulating member 2 to articulate laterally and/or vertically. As will be described in greater detail herein, an articulating member 2 adapted to articulate laterally, vertically, or both may have significant advantages.

Articulating member 2 may have a length L, a width W, and a thickness T. The length L need not be longer than the width W (and conversely, the width W need not be shorter than the length L) for the purposes of this application and the appended claims. Articulating member 2 may have a first surface 30, which is the top surface in this embodiment, and a second surface 32, which is the bottom surface in this embodiment. The distance between these two surfaces may define the thickness T of articulating member 2. The first surface 30 and/or second surface 32 may be coated with an adhesive and protected by a laminate layer (not shown). An operator, when applying an articulating member 2 to a substrate, may remove the laminate layer and adhere or affix the surface having the adhesive coating to the substrate. Articulating member 2 may also have a first side surface 16 and a second side surface 18. The distance between these two surfaces may define the width W of articulating member 2. The width W may vary, especially along the length L of articulating section 8.

Articulating member 2 may be comprised of non-rigid material, such as polymers, such as, for example, polyethylene, polypropylene and blends thereof, plastics, cellular materials, such as foam, including both open and closed cell foam, and other materials having elastic or resilient properties. First member section 4, second member section 6, and member sections other than articulating section 8 may be made of rigid or metallic materials.

Referring now to FIGS. 2, 3, and 4, depending on the contour of the substrate, articulating member 2 may be configured to be longer or shorter in length L, wider or narrower in width W, and/or thicker or thinner in thickness T. Articulating section 8 can also be longer or shorter, wider or narrower, and/or thicker or thinner depending on the contour of the substrate the member is intended to fit. Articulating section 8 may comprise of a number of alternating ridges 10 and furrows 12 that form a corrugated pattern. Valleys 28 may separate the individual ridges 10 and furrows 12. As noted above, the width W of the articulating section 8 may vary along the length L of the articulating section 8 as the section alternates between ridges 10 and furrows 12. Accordingly, the width W of the articulating section may be defined by the first side surface 16 and the second side surface 18.

Each ridge 10 and furrow 12 may have peaks 40. The peaks are shown in FIG. 2 as being rounded. Moreover, each valley 28 may have a valley base 29. In FIG. 2, the valley bases 29 are shown rounded as well. The rounded valley bases 29 allows the stress concentrations that form along the first side surface 16 and second side surfaces 18 to be distributed over a larger area when the articulating member 2 is articulated.

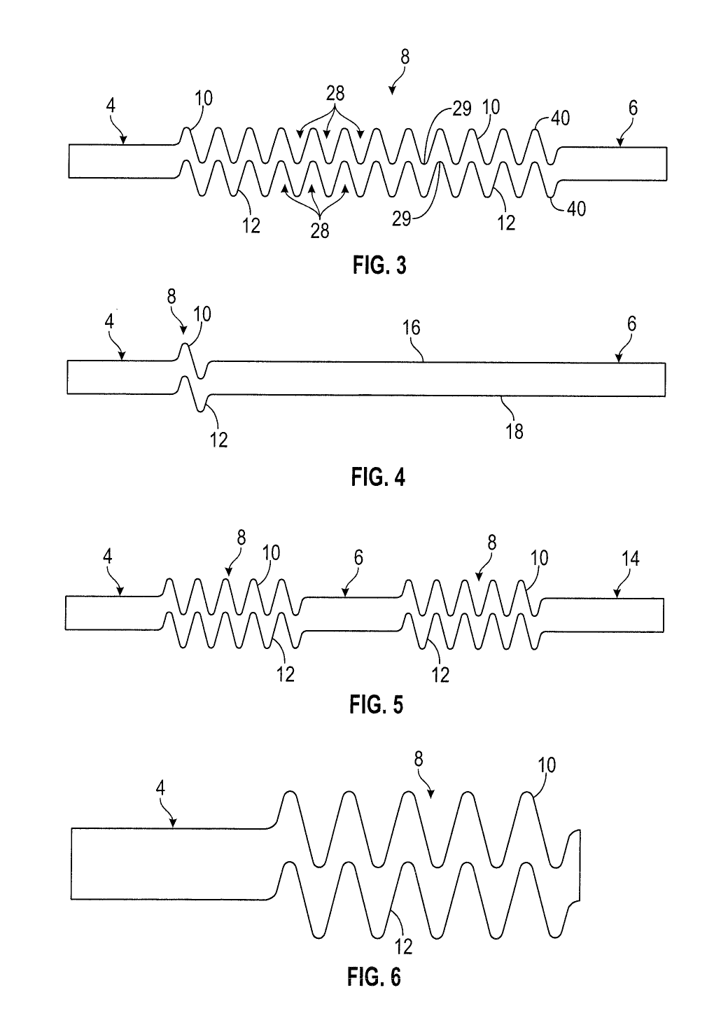

In FIG. 2, the articulating section 8 is shown with five ridges 10 and five furrows 12. In FIG. 3, the articulating section 8 is shown with twelve ridges 10 and twelve furrows 12. In FIG. 4, the articulating section 8 is shown with one ridge 10 and one furrow 12. Articulating section 8 may have n number of ridges 10 and n number of furrows 12, with n being a positive integer, including zero.

Referring now to FIG. 5, another exemplary embodiment of an articulating member 2 is shown. In this embodiment, articulating member 2 has two articulating sections 8 and a first member section 4, a second member section 6, and a third member section 14. Depending on the application, articulating member 2 may have n number of member sections and n₁ number of articulating sections, with n being a positive integer, including zero, and n₁ being a positive integer, excluding zero. Articulating member 2 may comprise of only an articulating section 8 without member sections. For instance, an articulating member 2 may comprise of only an articulating section 8 that may be wrapped three hundred sixty degrees around the circumference of a duct seal.

FIG. 6 illustrates an exemplary embodiment where articulating member 2 has a first member section 4 and an articulating section 8. This exemplary embodiment could be applied to a substrate having a generally planar contour with a curved surface at one of its ends, for example. The first member section 4 could be adhered flush to the planar surface of the substrate and the articulating section 8 could be articulated and adhered to the curved surface of the substrate.

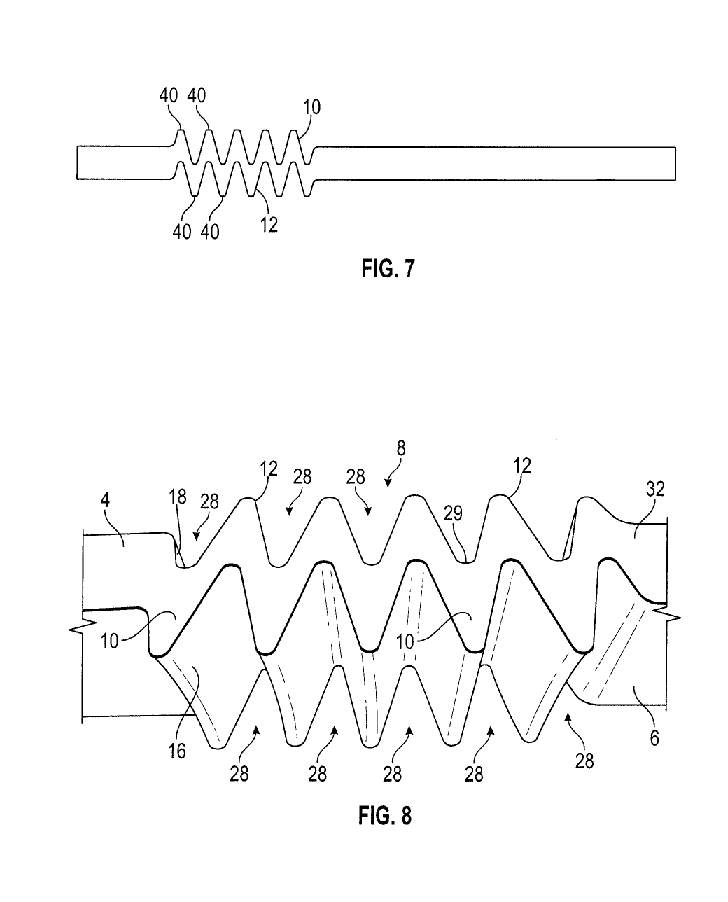

In FIG. 7, an exemplary embodiment of an articulating member 2 is shown with the peaks 40 of the ridges 10 and furrows 12 disposed in a flat-peak configuration. Other ridge 10 and furrow 12 configurations are possible.

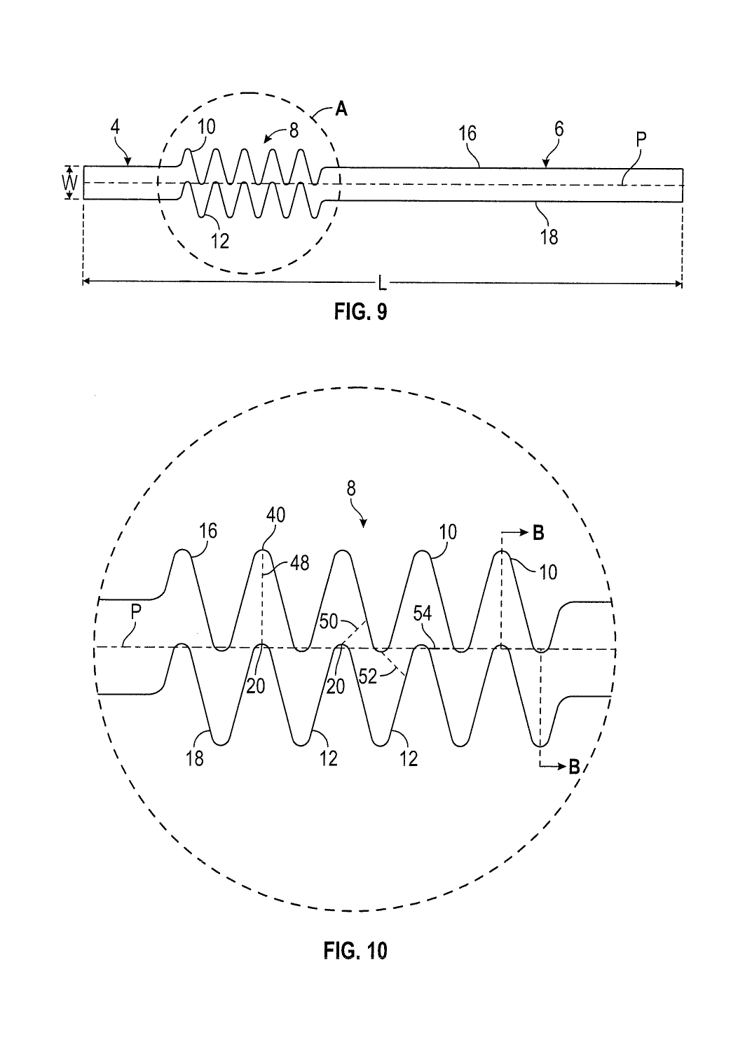

Referring now to FIGS. 8 and 9, an exemplary articulating section 8 will be described in more detail. As previously noted, the articulating section 8 may form a corrugated pattern of alternating ridges 10 and furrows 12. Valleys 28 may separate the individual ridges 10 and furrows 12. A reference longitudinal plane P may be oriented along the length L of the articulating member 2, and may delineate where a ridge 10 begins and where a furrow 12 ends, and vice versa. The reference longitudinal plane P is a reference plane that extends along the length L of articulating member 2 in its non-articulated equilibrium state and is not a physical object. The reference longitudinal plane P need not be centered along the width W of the articulating member 2. The ridges 10 of the articulating section 8 may extend generally outward from the reference longitudinal plane P in a first direction d1. The furrows 12 of the articulating section 8 may extend generally outward from the reference longitudinal plane P in a second direction d2. In this embodiment, second direction d2 is a direction generally opposite that of first direction d1. In other embodiments, first direction d1 and second direction d2 need not be generally opposite of one another. For example, first direction d1 may be a direction substantially normal to reference longitudinal plane P and second direction d2 may be angled with respect to reference longitudinal plane P by forty-five degrees. Ridges 10 and furrows 12 need not extend outwardly from reference longitudinal plane P the same distance. The ridges 10 may extend outwardly from the reference longitudinal plane P a greater distance than furrows 12, and the furrows 12 may extend from the longitudinal plane P a greater distance than ridges 10.

Referring now specifically to FIG. 10, a close up view of an exemplary articulating section 8 is illustrated. The first side surface 16 is shown outlining the ridges 10 and the second side surface 18 is shown outlining the furrows 12. A reference longitudinal plane P is oriented along the length L of articulating section 8. The reference longitudinal plane P is shown delineating the ridges 10 and furrows 12. Ridges 10 are shown extending in a first direction d1, with the furrows 12 extending in a second direction d2.

In this embodiment, the articulating section 8 has at least one cross section being disposed on one side of the reference longitudinal plane P for each ridge 10 and each furrow 12; the cross section being a section along the length L of the articulating section 8 that stretches from first side surface 16 to second side surface 18.

To illustrate, first width cross section 48 was chosen arbitrarily to extend from the peak 40 of a ridge 10 positioned on the first side surface 16 to an inboard position 20 positioned along the second side surface 18. First width cross section 48 is a cross section because it stretches from the first side surface 16 to the second side surface 18. The width of first width cross section 48 is disposed on one side of the reference longitudinal plane P for this particular ridge 10. Second width cross section 50 was chosen arbitrarily to extend from a position on the first side surface 16 to an inboard position 20 of the second side surface 18. The width W of second width cross section 50 is disposed on one side of the reference longitudinal plane P for this particular ridge 10. Likewise for the furrows 12, third width cross section 52 was chosen arbitrarily to extend from a position on the second side surface 18 to an inboard position 20 positioned along the first side surface 16. The width W of third width cross section 52 is disposed on one side of the reference longitudinal plane P for this particular furrow 12. In this embodiment, the cross section of the width W includes a cross section that is coplanar with the reference longitudinal plane P. For example, fourth width cross section 54 shown in FIG. 10 is coplanar with reference longitudinal plane P and is thus included as a cross section as defined in this embodiment. Where the width W of the articulating section 8 has at least one cross section disposed on one side of the reference longitudinal plane P, stress concentrations along the first and second surface 30, 32 and their neighboring regions may be reduced when the articulating member 2 is articulated vertically.

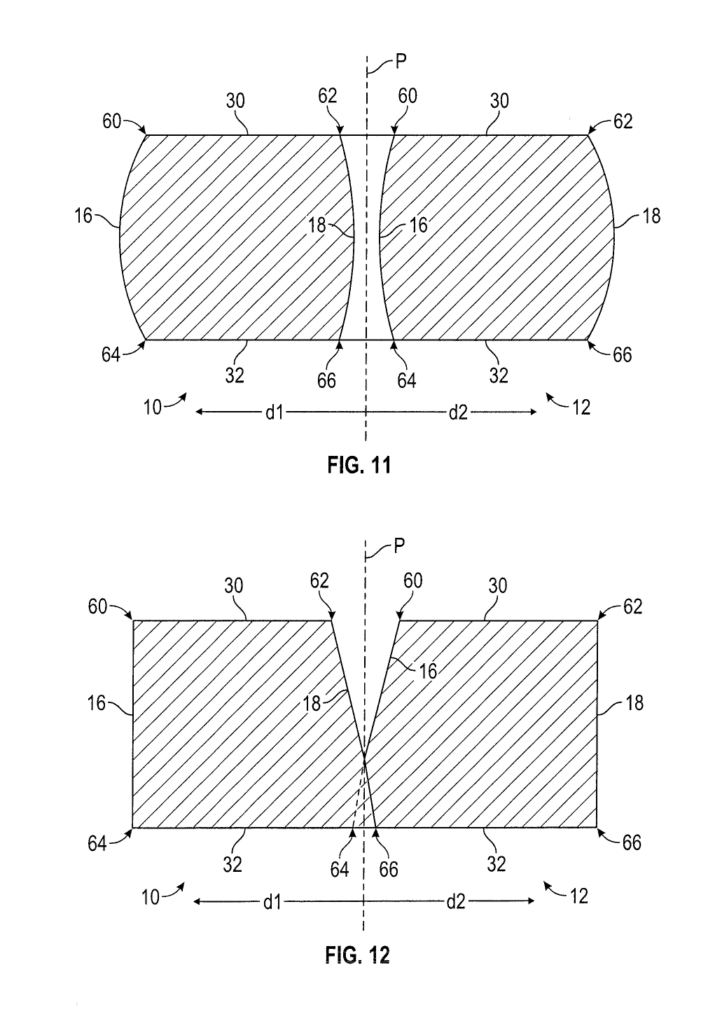

Referring now to FIG. 11, a cross section taken from line B-B of FIG. 10 depicts the cross sections of an exemplary ridge 10 and furrow 12. Reference longitudinal plane P is shown delineating the ridge 10 from furrow 12. First side surface 16 and second side surface 18 define the width W of the cross sections and first surface 30 and second surface 32 define the thickness T of the cross sections. At any given cross section along the length L of the articulating section 8, the articulating section 8 may have four edges: first edge 60, second edge 62, third edge 64, and fourth edge 66. For both the ridges 10 and furrows 12, the first edge 60 may connect the first surface 30 with the first side surface 16, the second edge 62 may connect the first surface 30 with the second side surface 18, the third edge 64 may connect the second surface 32 with the first side surface 16, and the fourth edge 66 may connect the second surface 32 with the second side surface 18.

As shown in FIG. 11, the cross section of the ridge 10 has each of its edges 60, 62, 64, 66 disposed inboard of the reference longitudinal plane P and furrow 12 has each of its edges 60, 62, 64, 66 disposed inboard of the reference longitudinal plane P. It should be noted that being disposed inboard of the reference longitudinal plane P could be a different direction depending on whether a ridge 10 or a furrow 12 is referenced. For example, in this embodiment, for a ridge 10 to have all of its edges 60, 62, 64, 66 disposed inboard of the reference longitudinal plane P, they all must be disposed on the same side of the reference longitudinal plane P in a first direction d1; and for a furrow 12 to have all of its edges 60, 62, 64, 66 disposed inboard of the reference longitudinal plane P, they must all be disposed on the same side of the reference longitudinal plane P in a second direction d2. When each ridge 10 and each furrow 12 has at least one point along each of its edges 60, 62, 64, 66 disposed inboard of the reference longitudinal plane P, the stress concentrations along the first and second surface 30, 32 and their neighboring regions may be reduced where the articulating member 2 is articulated vertically.

Importantly, in a machining process, such as die cutting, the side surfaces 16, 18 may bow or bulge outwardly along the thickness T of the articulating member 2 as shown in FIG. 11. This may be caused by the compressive force the die exerts on the material as the die is pressed into the material. So, a bulge of one of the side surfaces may not be inboard of the reference longitudinal plane P, but so long as each ridge 10 and each furrow 12 has at least one point along each of its edges 60, 62, 64, 66 that is disposed inboard of the reference longitudinal plane P, the stress concentrations along the first surface 30 and second surface 32 and their respective neighboring regions will be reduced.

Referring to FIG. 12, a cross section of an exemplary articulating section 8 is illustrated depicting a ridge 10 and furrow 12 delineated by a reference longitudinal plane P. In this embodiment, the second side surface 18 of ridge 10 and first side surface 18 of furrow 12 are shown angled along the thickness T of the cross section. For the second side surface 18 of ridge 10, second edge 62 is shown inboard of reference longitudinal plane P in a first direction dl, but fourth edge 66 is not shown inboard of reference longitudinal plane P in a first direction. For the first side surface 16 of furrow 12, first edge 60 is shown inboard of reference longitudinal plane P in a second direction d2, but third edge 64 is not shown inboard of reference longitudinal plane P in a second direction d2. In this embodiment, so long as each ridge 10 has at least one point along the first side surface 16 and at least one point along the second side 18 surface both positioned in a first direction d1 relative to the reference longitudinal plane P and each furrow 12 has at least one point along the first side surface 16 and at least one point along the second side surface 18 both positioned in a second direction relative to the reference longitudinal plane P, the stress concentrations along the first surface 30 and its neighboring regions may be reduced where the articulating member 2 is articulated vertically. In another embodiment, so long as least one ridge 10 has at least one point along the first side surface 16 and at least one point along the second side 18 surface both positioned in a first direction d1 relative to the reference longitudinal plane P and at least one furrow 12 has at least one point along the first side surface 16 and at least one point along the second side surface 18 both positioned in a second direction relative to the reference longitudinal plane P, the stress concentrations along the first surface 30 and its neighboring regions may be reduced where the articulating member 2 is articulated vertically.

Referring now to FIG. 20, an exemplary articulating member 2 is illustrated having a first member section 4 and an articulating section 8. In this embodiment, articulating section 8 may comprise of only ridges 10 extending from the reference longitudinal plane P in a first direction d1. Alternatively, articulating section 8 may comprise of only ridges 12 extending from reference longitudinal plane P in a second direction d2 (not shown). The reference longitudinal plane P may be oriented at the midpoint between the first side surface 16 and the second side surface 18 of the first member section 4 as shown in FIG. 20; other orientations are also possible. In this embodiment, the valley bases 29 of valleys 28 are positioned inboard of the reference longitudinal plane P in a second direction d2 relative to the reference longitudinal plane P. In this embodiment, articulating member 2 may be laterally articulated (albeit in a more limited range in the second direction d2 in this case) and may be articulated vertically. In this embodiment, so long as least one ridge 10 has at least one point along the first side surface 16 positioned in a second direction d2 relative to the reference longitudinal plane P, the stress concentrations along the first surface 30 and/or second surface 32 and their neighboring regions may be reduced where the articulating member 2 is articulated vertically. In another embodiment, so long as each ridge 10 has at least one point along the first side surface 16 positioned in a second direction d2 relative to the reference longitudinal plane P, the stress concentrations along the first surface 30 and/or second surface 32 and their neighboring regions may be reduced where the articulating member 2 is articulated vertically.

Where a furrow 12 extends from the longitudinal reference plane P instead of a ridge 10 (not shown in FIG. 20), so long as least one furrow 12 has at least one point along the second side surface 18 positioned in a first direction d1 relative to the reference longitudinal plane P, the stress concentrations along the first surface 30 and/or second surface 32 and their neighboring regions may be reduced where the articulating member 2 is articulated vertically. Moreover, in another embodiment, so long as each furrow 12 has at least one point along the second side surface 18 positioned in a first direction d1 relative to the reference longitudinal plane P, the stress concentrations along the first surface 30 and/or second surface 32 and their neighboring regions may be reduced where the articulating member 2 is articulated vertically.

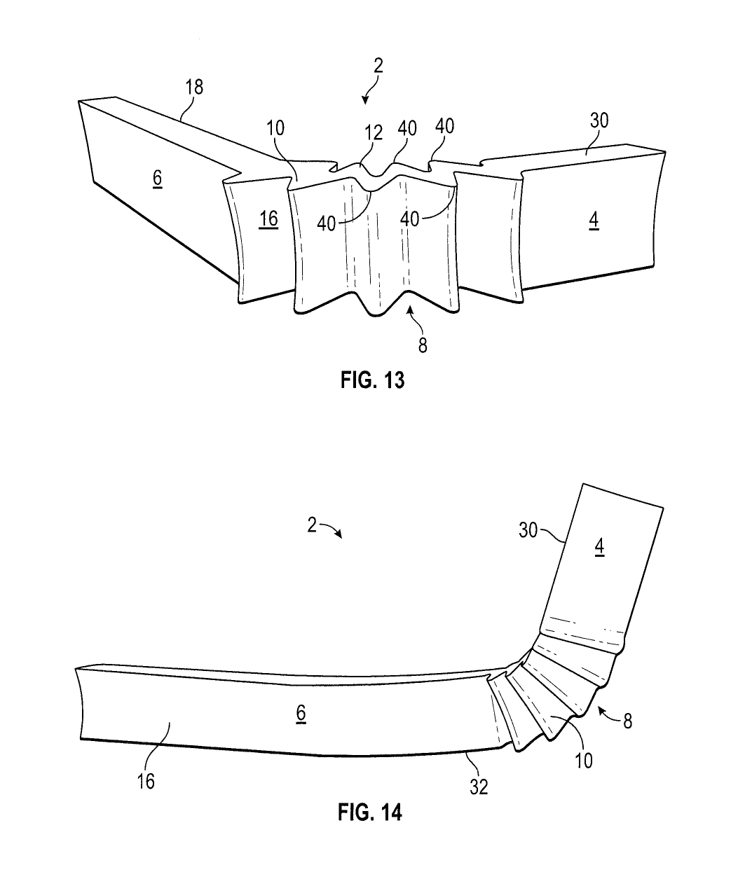

Referring to FIG. 13, an exemplary articulating member 2 is shown being articulated laterally. The first member section 4 and the second member section 6 are shown disposed substantially normal to one another. The articulating section 8 located between and contiguous with the first member section 4 and second member section 6 may allow for the articulating member 2 to move laterally due to its non-rigid material and geometry. More specifically, the alternating ridges 10 and furrows 12 and the valleys 28 spacing the ridges 10 and furrows 12 apart permit lateral articulation of the articulating member 2. The valleys 28 lessen the stress concentrations on the first and second side surfaces 16, 18 and their neighboring regions along the length L of the articulating section 8 as one of skill in the art will appreciate.

As illustrated in FIG. 13, articulating section 8 will experience compressive stress along the second side surface 18 and neighboring regions and tensile stress along the first side surface 16 and its neighboring regions. In this embodiment, the spaces between the peaks 40 of the furrows 12 are shown closer together (due to the compression of the material at the second side surface 18 and neighboring regions) and the spaces between the peaks 40 of the ridges 10 are shown spaced further apart than their equilibrium-state spacing (due to the tension of the material at the first side surface 16 and neighboring regions). It will be appreciated by one of skill in the art that the stresses along the first and second side surfaces 16, 18 would be reversed where the articulating member 2 is articulated laterally in the opposite direction.

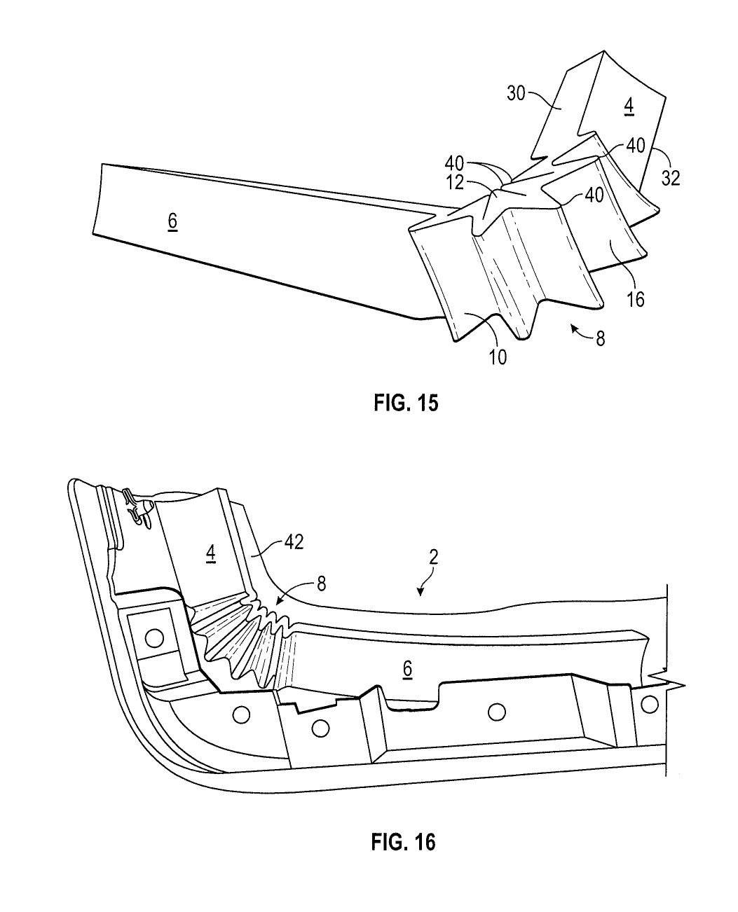

Referring to FIG. 14, an exemplary articulating member 2 is shown being articulated vertically. Articulating member 2 may have a first surface 30 and a second surface 32. In this embodiment, first surface 30 is the top and the second surface 32 is the bottom of articulating member 2. As illustrated, articulating member 2 will experience compressive stress along the first surface 30 and upper region of articulating section 8 and tensile stress along the second surface 32 and lower region of articulating section 8. It will be appreciated by one of skill in the art that if the articulating member 2 is articulated vertically in the opposite direction that articulating member 2 will experience tensile stress along the first surface 30 and upper region of articulating section 8 and compressive stress along the second surface 32 and lower region of articulating section 8.

Referring now to FIG. 15, an exemplary articulating member 2 is shown being articulated both laterally and vertically. The compressive and tensile forces experienced along the various surfaces described above will also be present for an articulated member 2 being both laterally and vertically articulated. Articulating member 2 will also experience other stresses when articulated both laterally and vertically as one of skill in the art will appreciate. Advantageously, an articulating member 2 adapted to articulate both laterally and vertically may be adapted to fit the complex contour of a substrate and additional manufacturing steps can be eliminated. For instance, an articulating member 2 may be formed from a larger sheet of material that has only one of its surfaces laminated with an adhesive and protective layer. If a member may only articulate laterally or vertically, an operator's options for orienting the member to fit along the contour of a substrate are limited. Where an articulating member 2 is configured to articulate laterally and vertically, the additional process of applying an adhesive coating and laminate layer to an additional surface of the articulating member 2 may be eliminated, and options for orienting the part are expanded.

Turning now to FIG. 16, an exemplary articulating member 2 is shown adhered to a substrate 42. Based on the contour of the substrate 42, which in this case is an automotive panel, the articulating member 2 may be articulated vertically such that its first member section 4, articulating section 8, and second member section 6 sit substantially flush with the substrate 42 to improve its adherence thereto.

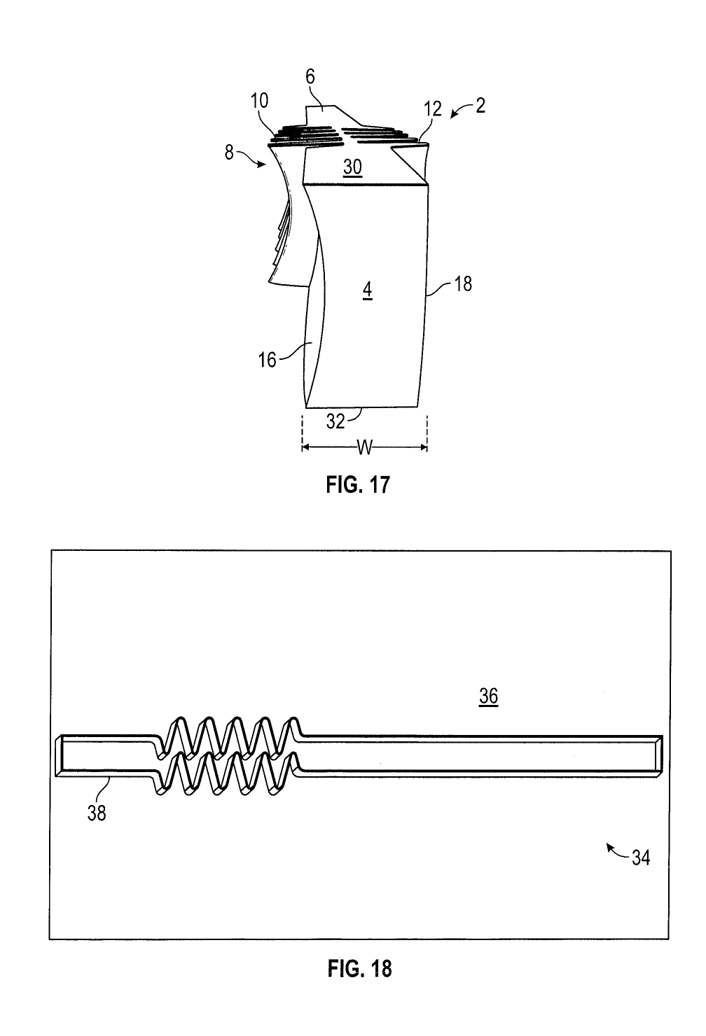

Referring to FIG. 17, a front perspective view of an exemplary articulating member 2 is shown. In this embodiment, the ridges 10 and furrows 12 extend outwardly from the reference longitudinal plane P beyond the width W of the first member section 4 and second member section 6. This permits, among other things, more surface area of the articulating section 8 to be adhered to a complex curvature or shape of a substrate.

An exemplary method for making an articulating member 2 will now be described. In one embodiment, an articulating member 2 may be formed by a die cutting process. In this embodiment, a material sheet having at least one of its surfaces coated with an adhesive is provided. The adhesive coating may be protected by a protective layer, such as a laminate layer, so that the material sheet does not inadvertently adhere to objects. The material sheet may be placed on a conveyor or the like and may be moved toward a die for cutting. A die may be pressed into the material sheet to cutout the desired blank or final shape. After the die cuts a blank, the conveyor may move the material sheet along such that an uncut part of the material sheet is aligned with the die. The die then cuts a second blank or final shape. The process is repeated for the desired quantity of parts.

Turning to FIG. 18, an exemplary die 34 is shown, which in this embodiment is a steel rule die. Other types of dies are also possible, such as forged and clicker dies. The die 34 may comprise of a base 36 and steel rule 38. Base 36 may be made of wood or acrylic, for example. The steel rule 38 may extend outwardly from base 36 in a direction generally normal to the base 36 as shown. The steel rule 38 may also have a section or sections extending outward from the base 36 in angled directions relative to the base 36. Foam (not shown) may be disposed along the steel rule 38 to help eject the material from the die 34 after the die 34 has been pressed into the material.

The steel rule 38 may be disposed about the base 36 in the pattern of the desired blank or final part shape. In this embodiment, the steel rule 38 is provided in the shape of an articulating member 2 having a first member section 4, an articulating section 8, and a second member section 6. Each ridge 10 and each furrow 12 of the articulating section 8 may have at least one cross section along their widths disposed on one side of the reference longitudinal plane P.

In another embodiment, the steel rule 38 may be disposed about base 36 such that, when pressed into a material sheet, an articulating section 8 is formed having the following: a first surface 30 and a second surface 32 defining the thickness of the articulating section 8 and a first side surface 16 and a second side surface 18 defining the width of the articulating section 8. The articulating section 8 may comprise of four edges: a first edge 60 connects the first surface 30 with the first side surface 16, a second edge 62 connects the first surface 30 with the second side surface 18, a third edge 64 connects the second surface 32 with the first side surface 16, and a fourth edge 66 connects the second surface 32 with the second side surface 18. And in this embodiment, the articulating section 8 has a number of ridges 10 and furrows 12, and each ridge 10 and each furrow 12 has at least one point along the first edge 60, second edge 62, third edge 64, and fourth edge 64 disposed inboard of the reference longitudinal plane P.

In another embodiment, the steel rule 38 may be disposed about base 36 such that, when pressed into a material sheet, an articulating section 8 is formed where: an articulating member 2 has an articulating section 8 having a length L, a width W, and a thickness T; and a reference longitudinal plane P oriented along the length. The articulating section 8 may also have at least one ridge extending outwardly from the reference longitudinal plane in a first direction and at least one furrow extending outwardly from the reference longitudinal plane in a second direction. The width W of the articulating section 8 may be defined by a first side surface 16 and a second side surface 18. And in this embodiment, each ridge 10 may have at least one point along the first side surface 16 and at least one point along the second side surface 18 being disposed in a first direction dl relative to the reference longitudinal plane P; and each furrow 12 may have at least one point along the first side surface 16 and at least one point along the second side surface 18 being disposed in a second direction d2 relative to the reference longitudinal plane P.

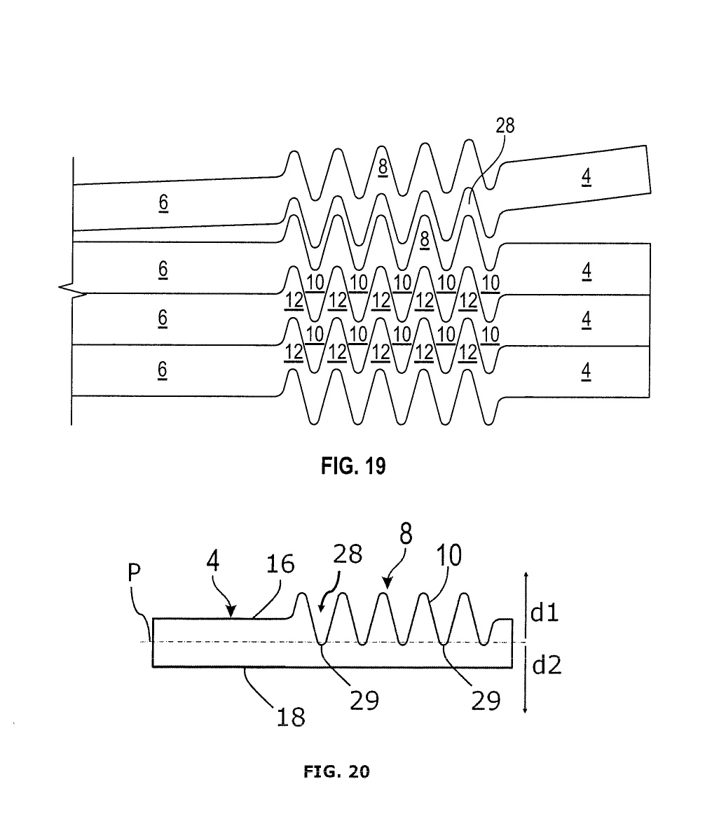

Referring now to FIG. 19, a sheet of material is shown with an exemplary nesting pattern for a number of exemplary articulating members 2. Due to the geometry of the articulating section 8 and first and second member sections 4, 6, the articulating members 2 can be arranged in a nesting pattern that produces minimal, if any, scrap between parts. The valleys 28 separating the ridges 10 of one articulating member 2 can be fit between the furrows 12 of the next articulating member 2 as shown.

The words used herein are understood to be words of description and not words of limitation. While various embodiments have been described, it is apparent that many variations and modifications are possible without departing from the scope and sprit of the invention as set forth in the appended claims.

What is claimed as new and desired to be protected by Letters Patent of the United States is:

1. A member, comprising:
an articulating section having spaced apart first and second surfaces connected by spaced apart first and second side surfaces; said articulating member having a length and a width, the width being defined by said spaced apart first side surface and second side surface;
a reference longitudinal plane oriented along the length;
the articulating section having at least one ridge extending outwardly from the reference longitudinal plane in a first direction and at least one furrow extending outwardly from the reference longitudinal plane in a second direction;
the width having a cross section extending from the first side surface to the second side surface positioned inboard of the reference longitudinal plane in the first direction for each ridge; and
the width having a cross section extending from the first side surface to the second side surface positioned inboard of the reference longitudinal plane in the second direction for each furrow.

2. A member, comprising:
an articulating section having a length, a width, and a thickness;
spaced apart first surface and a second surface defining the thickness with spaced apart first side surface and second side surface extending therebetween defining the width;
a first edge connecting the first surface with the first side surface, a second edge connecting the first surface with the second side surface, a third edge connecting the second surface with the first side surface, and a fourth edge connecting the second surface with the second side surface;
a reference longitudinal plane oriented along the length;
the articulating section having at least one ridge extending outwardly from the reference longitudinal plane in a first direction and at least one furrow extending outwardly from the reference longitudinal plane in a second direction;
each ridge having at least one point along the first edge, the second edge, the third edge, and the fourth edge positioned inboard of the reference longitudinal plane in the first direction; and
each furrow having at least one point along the first edge, the second edge, the third edge, and the fourth edge positioned inboard of the reference longitudinal plane in the second direction.

3. A member, comprising:
an articulating section having a length and a width;
a reference longitudinal plane oriented along the length;
the articulating section having at least one ridge extending outwardly from the reference longitudinal plane in a first direction and at least one furrow extending outwardly from the reference longitudinal plane in a second direction;
the width of the articulating section being defined by spaced apart first side surface and second side surface;
each ridge having at least one point along the first side surface and at least one point along the second side surface being disposed in the first direction relative to the reference longitudinal plane; and
each furrow having at least one point along the first side surface and at least one point along the second side surface being disposed in the second direction relative to the reference longitudinal plane.

4. A member, comprising:
an articulating section having a length and a width;
a reference longitudinal plane oriented along the length;
the articulating section having at least one ridge extending outwardly from the reference longitudinal plane in a first direction;
the width of the articulating section being defined by spaced apart first side surface and second side surface; and
at least one ridge having at least one point along the first side surface and at least one point along the second side surface being disposed in a second direction relative to the reference longitudinal plane.

5. A method for making a member, comprising the steps of:
pressing a die into a sheet of material, the die comprising:
a base and a rule, the rule being affixed to the base and extending outwardly from the base, the rule being disposed along the base such that an articulating member is formed when the die is pressed into the sheet of material, the articulating member comprising:
an articulating section having a length, a width, and a thickness;
a reference longitudinal plane oriented along the length;
the articulating section having at least one ridge extending outwardly from the reference longitudinal plane in a first direction and at least one furrow extending outwardly from the reference longitudinal plane in a second direction;
the width of the articulating section being defined by a first side surface and a second side surface;
each ridge having at least one point along the first side surface and at least one point along the second side surface being disposed in a first direction relative to the reference longitudinal plane; and
each furrow having at least one point along the first side surface and at least one point along the second side surface being disposed in a second direction relative to the reference longitudinal plane.
